(19) United States
(12) Patent Application Publication
(10) Pub. No.: US 2026/0243149 A1
(43) Pub. Date: Aug. 20, 2026

(54) SEISMIC MONITORING OF DISPOSAL WELLS

(71) Applicant: CONOCOPHILLIPS COMPANY, Houston, TX (US)

(72) Inventors: Jason BURKE, Houston, TX (US); Michael LEONARD, Houston, TX (US); Riki TASRIANTO, Houston, TX (US); Austin BEAM, Houston, TX (US)

(73) Assignee: CONOCOPHILLIPS COMPANY, Houston, TX (US)

(21) Appl. No.: 19/415,176

(22) Filed: Dec. 10, 2025

Related U.S. Application Data
(60) Provisional application No. 63/759,310, filed on Feb. 17, 2025.

(51) Int. Cl. E21B 41/00; G01V 1/30

(52) U.S. Cl. CPC E21B 41/0057; E21B 41/0035; G01V 1/307

(57) ABSTRACT

Methods and systems for disposing of fluids, such as brine or produced water or CO₂, in a disposal well that requires the injection well to be seismically monitored is described. Injection continues until a seismic event of threshold value caused by the injection is detected. The first injection point is then closed until the first event dissipates (e.g., pressure is reduced). Meanwhile, fluid is injected into an open injection point, again until a second seismic event is detected. Then the second injection point is closed and a third injection point (or the first if sufficiently dissipated) is opened and used for injection, and so on. In this way, the seismic risk is greatly reduced.

### PRIOR RELATED APPLICATIONS

This application claims priority to U.S. Ser. No. 63/759,310, filed Feb. 17, 2025 and incorporated by reference in its entirety for all purposes.

### FEDERALLY SPONSORED RESEARCH STATEMENT

Not applicable.

### REFERENCE TO MICROFICHE APPENDIX

Not applicable.

### FIELD OF THE DISCLOSURE

This invention relates generally to methods and systems for safely disposing of disposal fluids in disposal wells with reduced risk of seismic disturbances.

### BACKGROUND OF THE DISCLOSURE

The process of oil and gas production creates a significant amount of “produced water” that is brought to the surface along with any oil and gas that is produced. It is separated from the hydrocarbons and may have high salt, some remaining hydrocarbons, and various industrial compounds. Companies can- and do-recycle the produced water by cleaning it and reusing it. The cleaned water can be injected back into working reservoirs for reuse in gathering any remaining oil or gas, for hydraulic fracturing, for pressure support, and the like. However, companies may eventually discard the saltwater or brine at a saltwater well disposal (SWD) site.

There are several benefits to using SWD wells over other methods of wastewater management, such as:
SWD wells can be located on-site, reducing transportation costs and spill risk.
Injecting produced water deep underground helps to keep it away from surface waterways.
Produced water injection can help increase reservoir pressure, enhancing oil recovery rates.

Placement of high-pressure disposal wells requires identification of suitable natural underground formations with sufficient porosity to accept disposal fluids and sealed above by a layer of impenetrable rock (sealing layer). In addition, the injection usually occurs several thousand feet below the groundwater table and the well is also cased and cemented to prevent release of the salt water. See FIG. 1. The injected waste is under tremendous pressure at these great depths, which also helps prevent it from moving up through the rock formations.

This invention provides an additional risk reduction methodology for safely injecting disposal fluids into suitable wells.

### SUMMARY OF THE INVENTION

The invention generally relates to methods of injecting disposal fluids into disposal wells, such as SWD wells, wherein the injection is seismically monitored. When a significant seismic event is detected, injection is ceased at a first injection point and moved to a second injection point at least 100 meters away until seismicity dissipates. These steps are repeated in one or more wells until the fluid is entirely injected or until the reservoir is full (e.g., at a pressure maximum). In this way, risks of high pressure injection are mitigated and the operator remains within regulatory limits.

In some embodiments, it may be necessary to install seismic detectors at suitable locations, but in other embodiments an array of seismic detectors may be already laid out in a play, e.g., where a field was recently hydraulically fractured. For vertical wells, the seismic detectors should be placed close to (within 20 or 10 feet) or on the well pad for each vertical well. For horizontal wells completed with controllable injection points, the seismic detector should generally overlay each injection point.

We plan to test our system by equipping an array of wells with an array of seismometers and then merely manually adjusting the injection profiles as events are detected. However, in phase two of development we will implement an automated system for changing the injection profiles as events are detected. This should be quite doable and only requires data collection and analysis, as well as multiwell piping and control systems-issues that are well understood and in common use in oil and gas development.

The method is preferably applied to horizontal wells, as monitoring seismic events is easy whenever the seismometers can be spread out along the length of the well and where well lengths are on the order of tens of thousands of meters so multiple controllable injection points are possible. However, it is also possible to apply the method to vertical wells by switching to a distant vertical well when seismicity approaches or exceeds limits. Further, the use of vertical wells can obviate sleeve cost, although a sufficiently deep well may also have more than one suitable injection point and be equipped with sleeves or other injection control mechanisms.

In some embodiments, horizontal wells are completed with controllable injection points, which can be obtained with various combinations of different length injection tubings, casing perforations, plugs, packers, and the like, to control where injection into the reservoir occurs—e.g., only into the porous layer, and not any layers above it. However, one preferred controlled injection point technology is multi-open-and-close stimulation sleeves, also known as “frac sleeves” or “MOC frac sleeves.” In this case, seismicity detectors are installed on the surface over each MOC frac sleeve.

In the disposal operations for horizontal wells equipped with MOC frac sleeves, one or more sleeves are open, and injection of disposal brine begins. When the seismicity reaches a set threshold, the open sleeve(s) are closed, and one or more sleeve(s) are opened some distance away from the seismic event. This may be in the same well or in a new well, as needed. The respite in brine disposal at the first sleeve(s) allows the seismicity and/or pressure to subside, thus preventing any hydraulic fracturing or fault lubrication, which has the potential to allow fluid movement. The sleeves can be opened and closed along the well multiple times allowing for a “smart” disposal injection plan.

There are many multiple open-and-close stimulation sleeves available on the market that may be used in the inventive methods and systems, including any hydraulic or mechanically shifting sleeves, such as darts, endless frac sleeves, plug drop sleeves, ball activated and coiled tubing activated sleeves.

For example, the CoilShift™ Precision CT frac sleeve by Schlumberger® can be opened, closed, and again re-opened using the CT frac sleeve shifting tool. Precision recloseable CT fracturing sleeve by Steelhause™ Canada Ltd is a similar tool.

TSS Group™ has a reclose able hydraulic toe sleeve that is opened hydraulically by pumping an activation ball into a special seat and applying pressure. Circulation ports are opened after activation ball is seated and the pressure is increased to the activation pressure value.

Multiple open/close functionality in the i-Frac™ multi-open/close (MOC) sleeve system is available from NOV™ Energy Equipment. Each sleeve can be independently and reliably shifted open and closed multiple times using the i-Shift™ tool.

Recloseable coiled-tubing-activated frac sleeves can also be used. In these systems, the sleeves are opened by a tool on the coiled tubing. NOV Energy Equipment, for example, has the Bulldog™ frac MOC sleeve technology, which features a mechanical shift, and multiple open-and-close sleeves activated using a coiled-tubing-deployed Bulldog frac BHA. This allows operators to locate, shift open, and stimulate each isolated stage. The Ragnarok™ unlimited multistage frac system is another multi-open-close frac sleeve by NOV.

The Ratek™ by NCS Multistage™ together with the Ratek Proppex™ re-open tool is a BHA deployed on coil or jointed tubing.

In one embodiment, the invention includes a horizontal well with multiple injection ports, each port independently controlled. The injection ports may be controllable directly through a wired, pneumatic, pressure, or mechanical system. In another embodiment the injection ports may have an associated pressure sensor on the reservoir side of the injection well. In another embodiment the injection port is controlled by a pressure sensor on the reservoir side of the injection port. The injection port and pressure sensor may be wired to the surface through one or more wires that transmit local reservoir pressure and injection pressure to the surface in real time. The injection port volume may be automatically controlled by said reservoir pressure sensor increasing or decreasing flow through the injection port to maintain a steady pressure in the local reservoir. Seismic detection input may then automatically switch from one injection point to a distant injection point.

Any seismometers may be used in the method, provided they are sensitive enough to detect seismic events of moment magnitude (Mw) dictated by local regulations. They are preferably set out along the length of a horizontal well at appropriate intervals and at or near the pad of a vertical well. Seismometers may already be present in many cases, as seismometers are employed for a variety of uses in oil fields, including uses to monitor hydraulic fracturing. Here the usage is similar, but fracturing and other seismic events are to be avoided.

The purpose of the seismometers is to detect the beginning of a seismic event, such as fracture formation or fault lubrication, at a given injection point. When detected, injection is halted at that location so that the pressures can dissipate. Injection instead continues at a distant location, at least until another seismic event is detected at the new location. Since horizontal wells can be on the order of kilometers, the long well provides plenty of opportunity to avoid pressure buildup and thus avoid fracture propagation and risking potential contamination of any ground water source layers. Thus, a single well can be used until pressure limits are reached, and injection switched to a new well as needed.

The S-400 Seismic Sensor (hydraulic fracturing sensor) has been designed for seismic events recording during hydraulic fracturing. Many additional options become available when considering geophones, seismometers or accelerometers, and the like. Although we expressly plan to use seismometers in our work, there are many methods of detecting seismic events that could be used herein, including known and to be developed technologies. Thus, it may also be possible to monitor localized pressure increases by pressure monitors near the sleeves, or monitor seismicity with geophones, accelerometers, tiltmeters, DAS, LFDAS, and the like. Combination methods are also possible, e.g., pressure sensors and seismometers.

As used herein, a “horizon,” is an isolated reservoir layer separated from other reservoir layers by one or more nonporous layer creating unique reservoirs for injection. Horizons may be shallow, intermediate or deep reservoirs dependent upon the amount of overburden and thickness of the interbedded layers.

As used herein a “disposal reservoir” is any reservoir zone that is porous enough to accept a disposal fluid and is bounded above and preferably below by impermeable layers.

As used herein a “disposal fluid” is any fluid that is disposed of by injection deep into a disposal well or reservoir. Typically brine, produced water, CO₂ and the like are disposed of by injection.

An “injection point” is a discrete location in a well where fluids are injected and enter the reservoir. Injection points can be controlled by a number of means, including the use multi-open and close sleeves, coiled tubing openings at discrete locations, plugs, packers, combinations, and the like.

Any claim or claim element introduced with the open transition term “comprising,” may also be narrowed to use the phrases “consisting essentially of” or “consisting of” and these inventions are expressly contemplated herein. However, the entirety of claim language is not repeated verbatim in the interest of brevity herein.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim.

The phrase “consisting of” is closed and excludes all additional elements.

The phrase “consisting essentially of” excludes additional material elements, but allows the inclusions of non-material elements, such as injection equipment, that do not substantially change the nature of the invention.

The following abbreviations are used herein:

| ABBREVIATION | TERM |
|---|---|
| MOC | Multiple open and close |
| SWD | Saltwater disposal |
| DAS | Distributed acoustic sensing |
| LFDAS | Low frequency DAS (<1 Hz, preferably <0.1 HZ). |
| MSA | micro-seismic array |

### BRIEF DESCRIPTION OF THE DRAWINGS

FIG. 1. (Prior art) Injection of wastewater into a saltwater disposal well.

FIG. 2A-H. The inventive method of tracking seismic events at an initial MOC frac sleeve and moving injection to a distant sleeve once detected, thus mitigating seismic risk.

FIG. 3A-H. The inventive method of tracking seismic events at an initial vertical well and moving injection to a distant well once detected, thus avoiding seismically induced problems.

FIG. 4A-C. The inventive method of tracking seismic events at a deep vertical separated by multiple porous zones and moving injection from one zone to the other when seismic event is detected at a zone.

FIG. 5A. A seismic detector, communication and piping system.

FIG. 5B. Communication system connected to the seismic detector.

### DESCRIPTION OF EMBODIMENTS OF THE INVENTION

The invention provides a novel method and system for disposing of fluids, such as brine, produced water, CO₂ and the like in a disposal well. Generally speaking, the disposal well is monitored during injection for seismic events that approach or exceed regulatory thresholds. When a problematic seismic event is detected, that injection point is shut down until the seismicity decreases, and instead a new injection point is opened up a sufficient distance away to avoid contributing to local seismicity. Once seismicity dissipates, injection at the first site may be renewed.

In a horizontal well, the well may be completed with multiple injection tubings (e.g., toe and heel injection tubings), or sliding sleeves, and the like, to allow control over the injection point. For vertical wells, one can simply move injections to a new vertical well at some distance, although vertical wells can also be completed with controllable injection points such as sleeves. Even in vertical wells, the injection point must be controlled so that fluids are deposited in the correct layer of the reservoir, not throughout the vertical length of the well, although this may be as simple as only perforating the casing in the disposal zone.

In one embodiment, a horizontal disposable well is completed with several multi-open and close sleeves, typically used for hydraulic fracturing, and the well area monitored for seismic events when injecting a disposal fluid. When a seismic event is detected, that sleeve is shut down, and a distant sleeve (either in the same well or a distant well) opened for continued injection until at the pressure at the first sleeve dissipates, thus preventing fracture propagation and/or potential contamination of groundwater by the disposal fluid. This is repeated as needed throughout the field to dispose of all fluids.

Ideally, the system will be automated, such that movement of the injection point to a seismically quiet region is automatic. However, in our proof of concept work we will test manual systems.

The invention includes any one or more of the following embodiments, in any combination(s) thereof:
A disposal method, said method comprising: injecting a fluid to be disposed of into a first controllable injection point in a disposal well in a reservoir; monitoring seismic activity in said reservoir; continuing said injecting step until a seismic event of a predetermined value is detected, and then switching to injecting said fluid into a second controllable injection point at least 100 meters from said first injection point, said second controllable injection point in said disposal well or in a second disposal well.
Any method or system herein described, wherein said first controllable injection point and said second controllable injection point are in a horizontal disposal well, preferably in a single horizontal disposal well, although additional wells may be used as injection continues. Preferably, each controllable injection point is fitted with a multi-open-and-close hydraulic fracturing sleeve (MOC frac sleeve).
Any method or system herein described, wherein said first controllable injection point and said second controllable injection point are in a single vertical disposal well. Alternatively, they may be in different wells. Combinations are also possible, where first and said second controllable injection points are independently in a horizontal disposal well or in a vertical disposal well or combinations thereof.
Any method or system herein described, wherein said method has reduced seismic risk than a disposal method performed without said seismic or microseismic detection, closing and switching steps.
A system for disposal of fluids in a reservoir, said system comprising: a plurality of vertical disposal wells or horizontal disposal wells in a reservoir, each disposal well cased and cemented; each disposal well fitted with controllable injection point(s) (such as MOC frac sleeves) for directing fluid into a porous layer of said reservoir; said porous layer under an impermeable layer under a soil layer; a seismic detector on or in said soil layer over each said controllable injection point(s); each said seismic detector operably connected to a computer system configured to assign a seismic event of a value greater than a predetermined threshold value to a particular controllable injection point.

The computer system may also be operably connected to a piping control system configured to switch flow to another controllable injection point when said seismic event of a value greater than a predetermined threshold value is detected.
A method of disposing of brine in a saltwater disposal well, said method comprising injecting a brine into a first multi-open-and-close (MOC) frac sleeve in a saltwater disposal well until a seismic event is detected at said open frac sleeve, and then closing said first MOC frac sleeve and switching to injecting said brine into a second MOC frac sleeve at least 100 meters from said first MOC frac sleeve, and repeating as needed for n MOC frac sleeves.

If needed, the well may be completed with said MOC frac sleeves, but in many cases, this step is omitted because the well is already completed in this manner. Likewise, if needed the seismometers or other fracture detection devices are deployed at or near the well, but in fields that are already fitted with such devices (e.g., for fracking) the step can be omitted.
A method of disposing of brine in a saltwater disposal well, said method comprising: injecting a brine into a first vertical saltwater disposal well (SWD) until a seismic event is detected at said first well; and then closing said first well and switching to injecting said brine into a second vertical SWD well at least 100 meters from said first well; repeating as needed for n vertical SWD wells; wherein said method has reduced seismic risk than a disposal method performed without said seismic detection, closing and switching steps.
A system for disposing of fluids in disposal wells, said system comprising: a plurality disposal wells (SWD) and a plurality of seismic detectors, each SWD adjacent a seismic detector; each said SWD at least partially positioned in a porous layer that can hold fluids to be disposed; said porous layer below one or more impermeable rock layer(s); said one or more impermeable rock layer(s) positioned below a groundwater level; said groundwater level below a soil level; said plurality of seismic detectors operably connected to a computer system configured to detect and assign a microseismic or seismic event of a value greater than a predetermined threshold value to a particular SWD.

Any method or system herein described, said predetermined threshold value at least 0.2 Mw, at least 0.5 MW, at least 1 or 1.5 Mw, at least 2 or 2.5 Mw, at least 3 or 3.5 Mw.

Any method or system herein described, said plurality of devices for detecting seismic events or seismic detectors are selected from seismometers, accelerometers, tiltmeters, DAS, LFDAS, geophones, and the like.

Any method or system herein described, wherein said frac sleeves are sliding frac sleeves activated with a ball and pressure change, or sliding frac sleeves activated with a tool mounted on a coiled tubing.

Any method or system herein described, wherein said second controllable injection point at least 100 meters away, preferably at least 200 or 500 meters, and most preferred at least 1000 or 1500 meters, or even at least 2000 meters. The optimal distance will depend both on the geology of the area as well as local regulations. An array of seismic detectors will also provide information as to how far away the second injection point should be, as it should move past detectable seismicity.

The present invention is exemplified with respect to disposal of oilfield briny fluids in SWD wells. However, this is exemplary only, and the invention can be broadly applied to the disposal or sequestration of any fluids underground, such as CO₂, CH₄, produced water, radioactive water, contaminated fluids, and the like. The following examples are intended to be illustrative only and not unduly limit the scope of the appended claims.

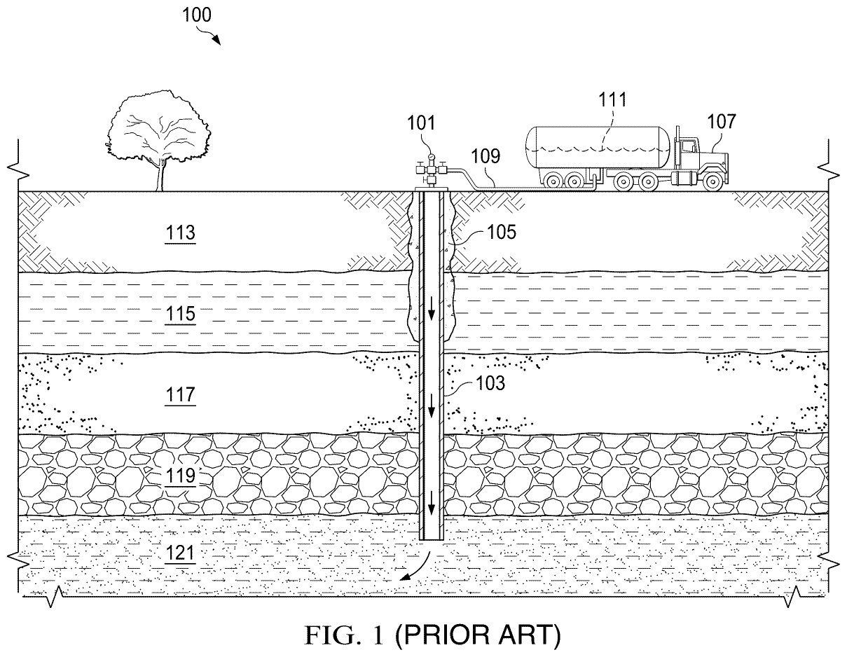

FIG. 1 shows a typical prior art disposal well system 100, with wellhead 101 on well 103 that is typically cased and cemented 105, at least over the groundwater layer(s). Ideally, the cement 105 protects the entirety of the water layers, as shown.

Truck 107 and line 109 deliver disposal fluid, herein briny water 111, to the well 103. The well 103 is very deep, well under soil layer 113, which overlies groundwater layer 115, which may have one or more base layers 117. Under the groundwater layer is a rock layer 119 that is generally impermeable and serves to confine the groundwater layer 115 as well as wastewater layer 121, thus separating them. Although shown as vertical, such wells can also be horizontal, and many additional layers (same or different) may be present.

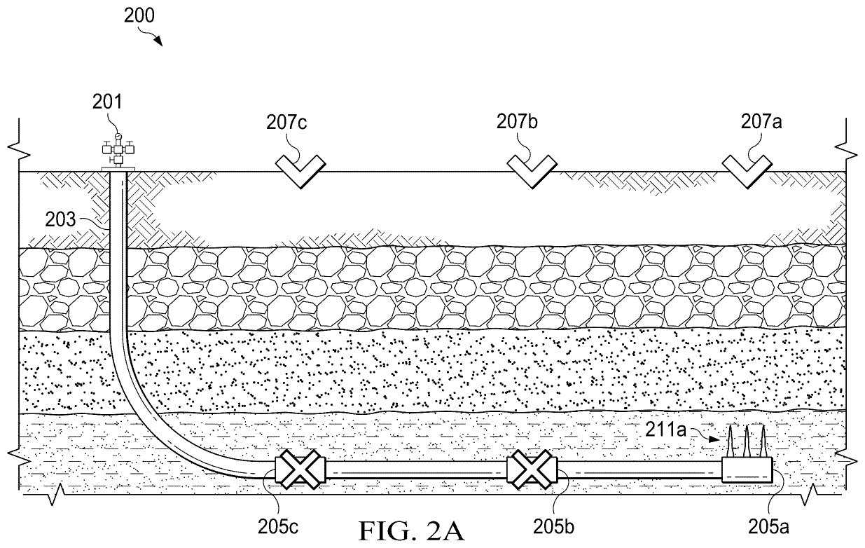

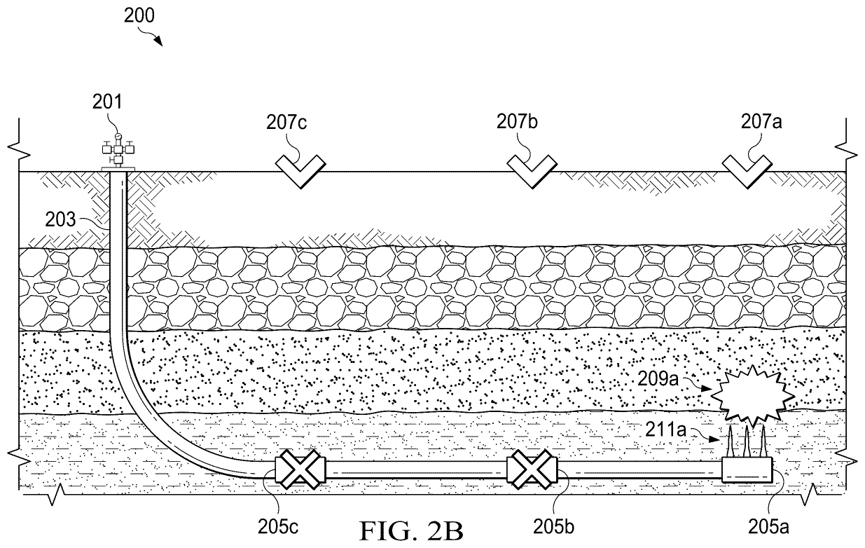

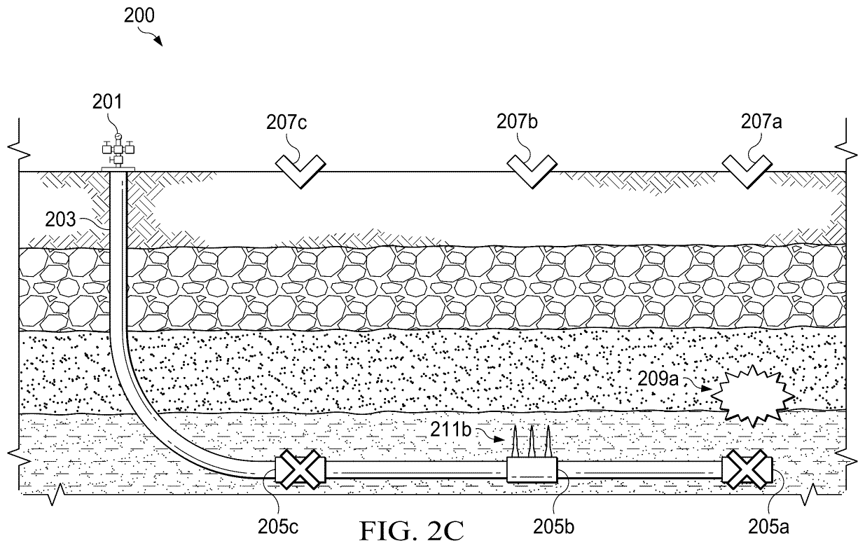

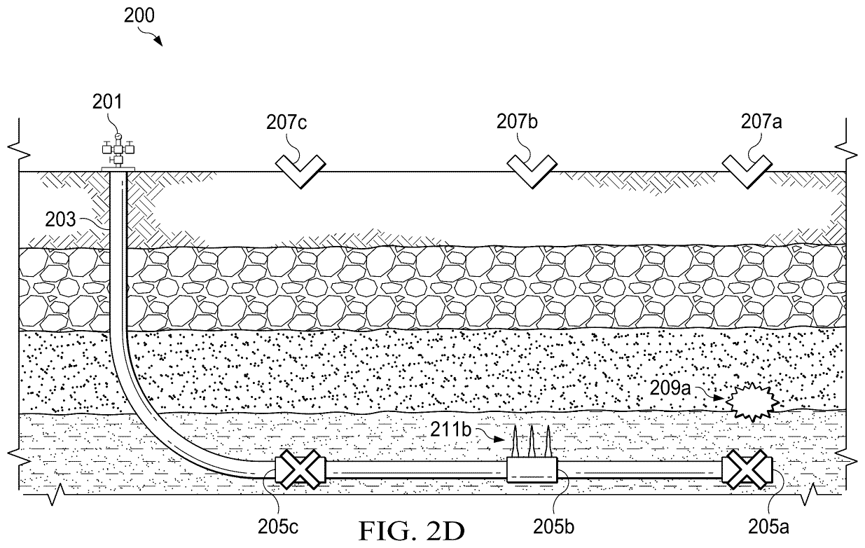

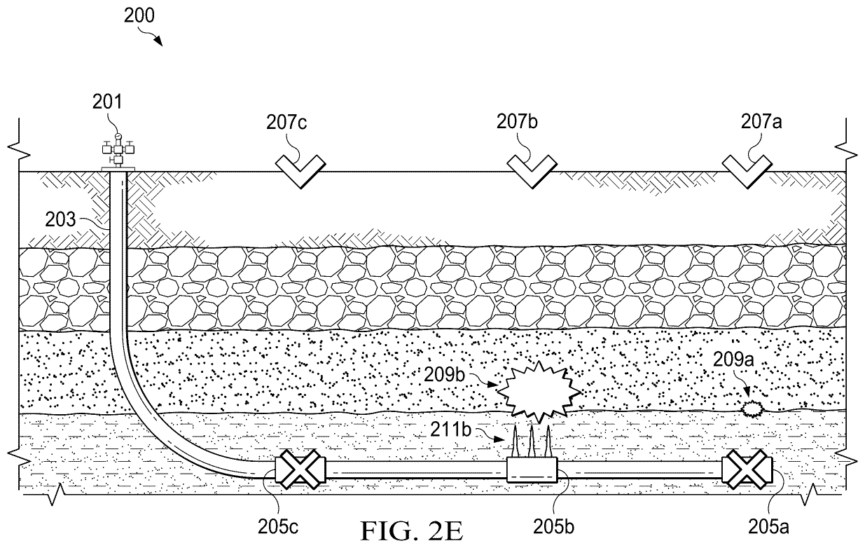

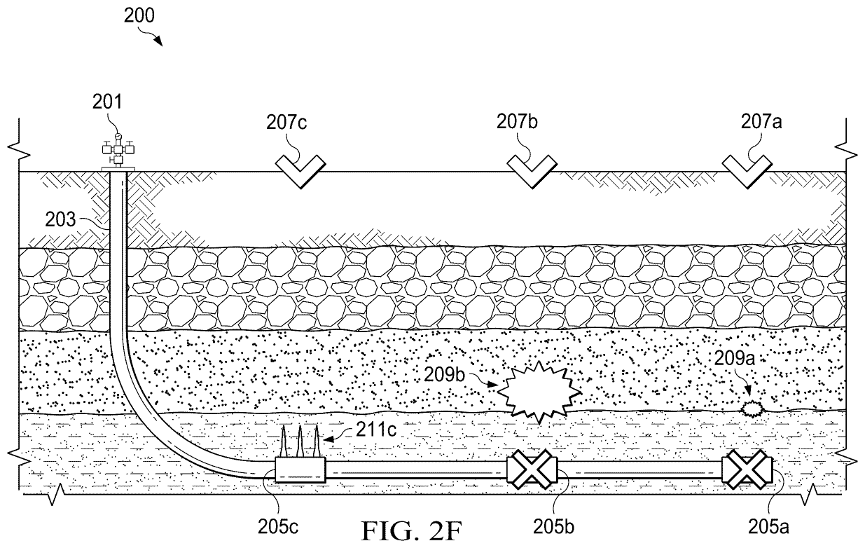

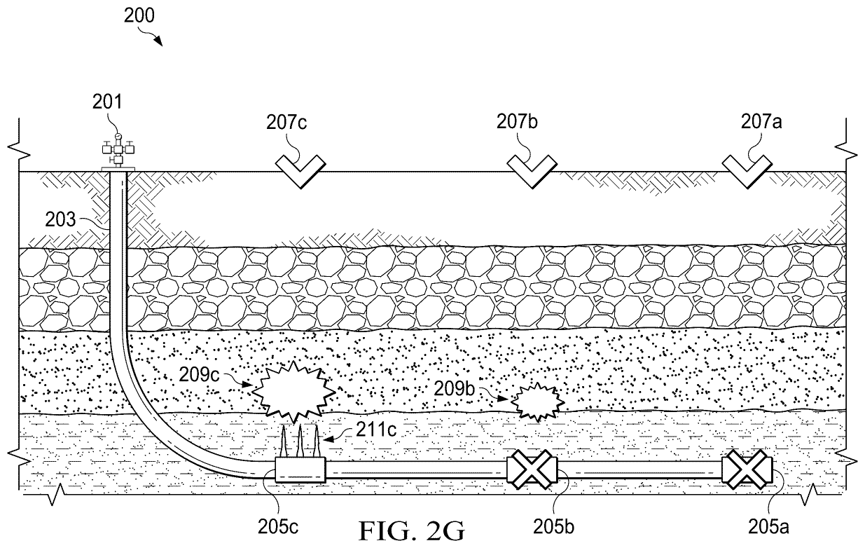

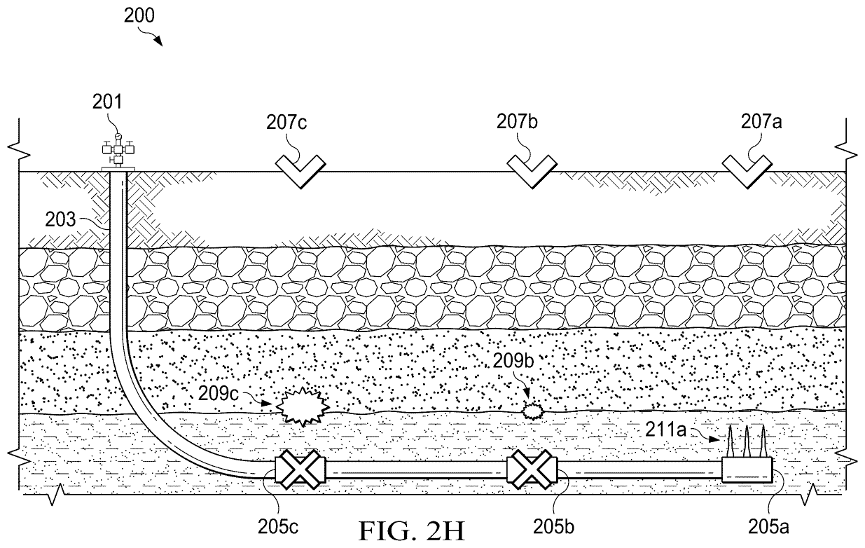

FIG. 2A-H shows the method and system 200 in schematic form, and although layer details, casing and cement are omitted, one may refer to FIG. 1 for typical well construction and rock/water/soil layers.

Here we see wellhead 201 at the top of well 203, which is completed with MOC sliding sleeves 205a-c. Although three are shown for simplicity, ideally the frac sleeves will be positioned at least 100 meters apart. Seismic sensors 207a-c are placed over the well in positions suitable for monitoring microseismic or seismic events at each frac sleeve.

In each of the panels we see injection 211a-c until a seismic event is detected 209a-c (FIG. 2B), at which time that frac sleeve is closed and injection moved to a new frac sleeve, as far away as needed for the geology and applicable regulations.

In more detail, in FIG. 2A we see injection in open sleeve 205a, with sleeves 205b-c closed. This continues until the pressure builds sufficiently that the stress overcomes the minimum principal stress, thus initiating a fracture 209a which can be detected by sensitive equipment, here shown in FIG. 2B seismometer 207a. In FIG. 2C, sleeve 205a is thus closed to allow the pressure around that sleeve to dissipate, preventing fracture propagation, and instead, sleeve 205b is opened for injection. Eventually, in FIG. 2D we see the pressure at sleeve 205a subside. In FIG. 2E the pressure around sleeve 205b exceeds minimum and another event 209b is detected, so the sleeve 205b is closed in FIG. 2F and injection switched to 205c. In FIG. 2G an event 209c is detected at 205c, so in FIG. 2H sleeve 205c is closed, and injection switched back to 205a.

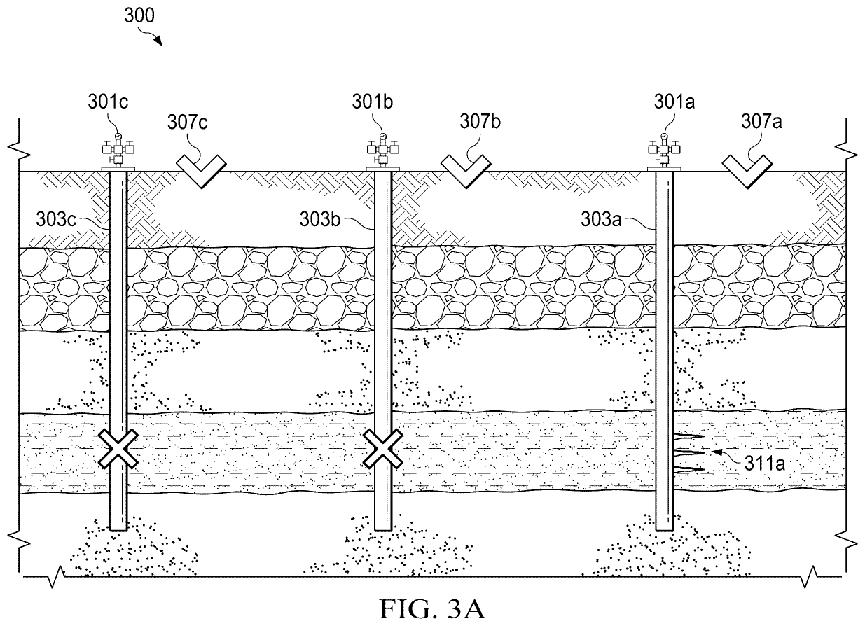

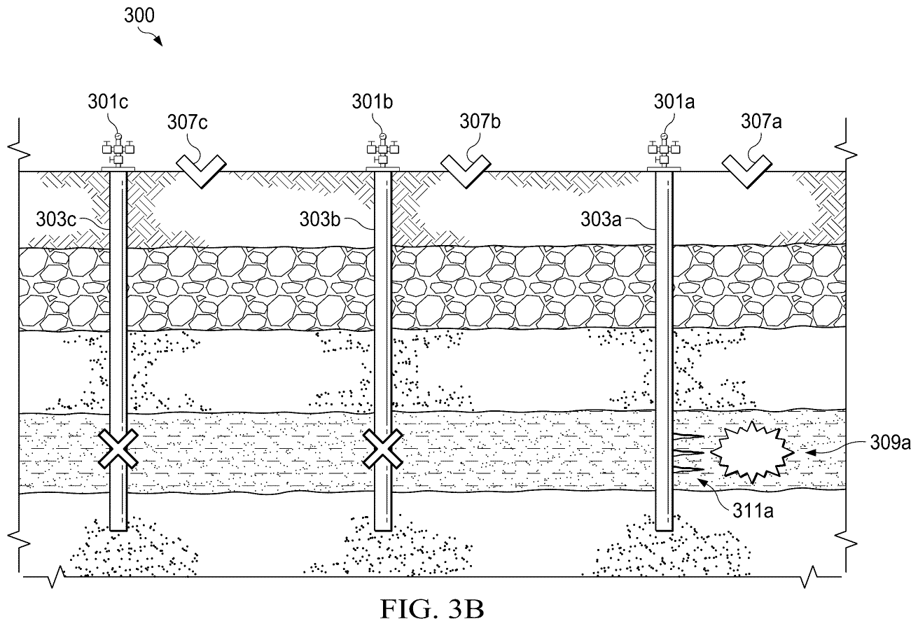

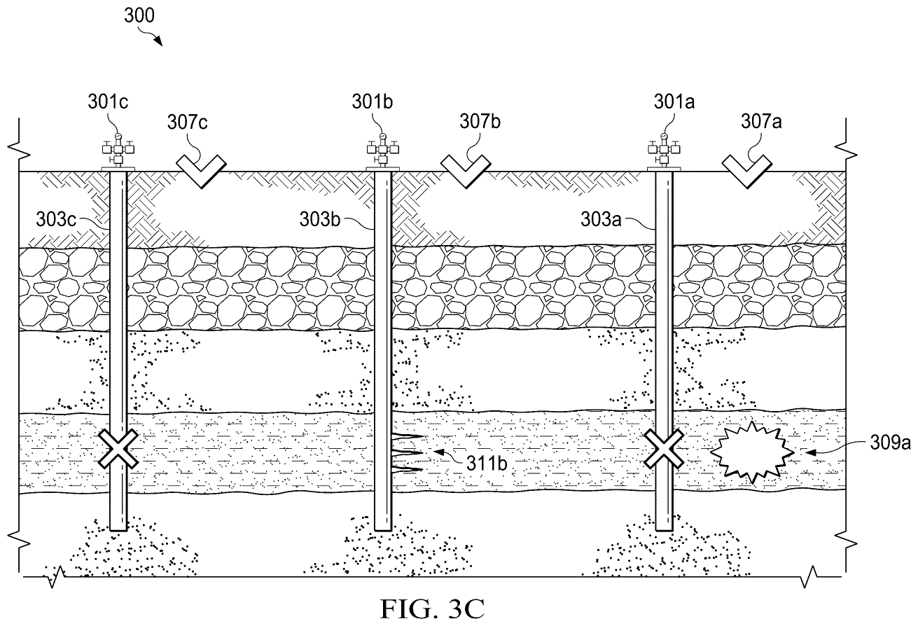

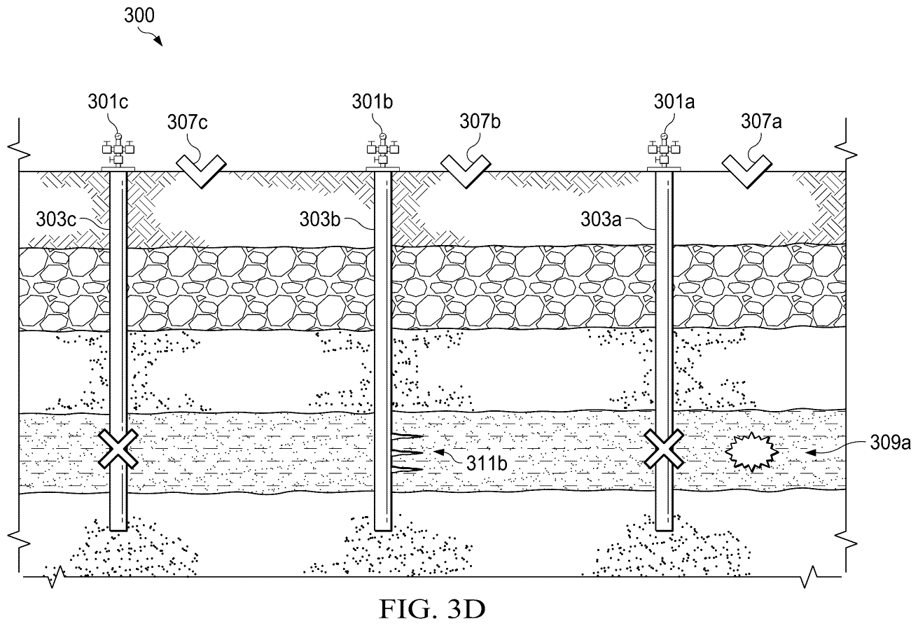

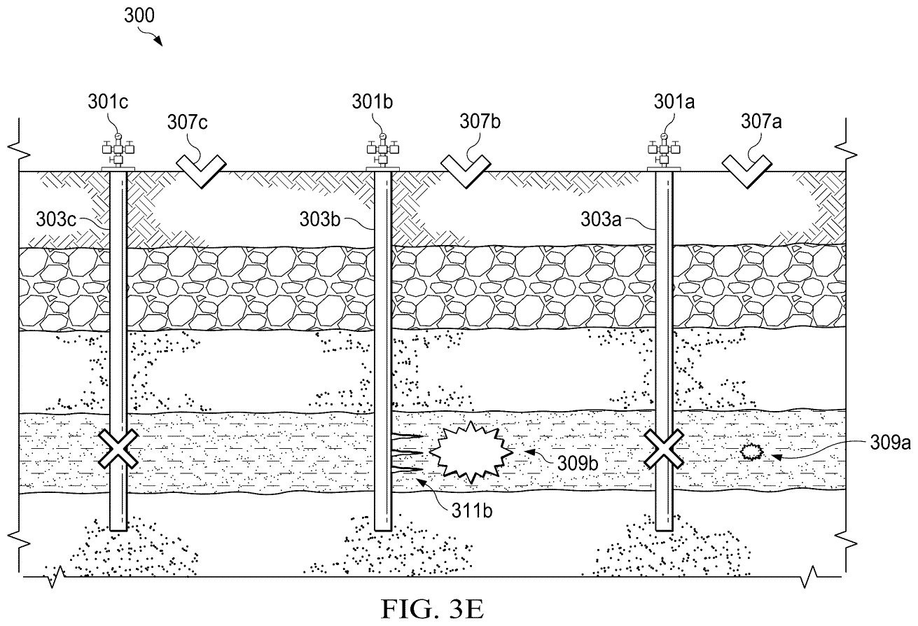

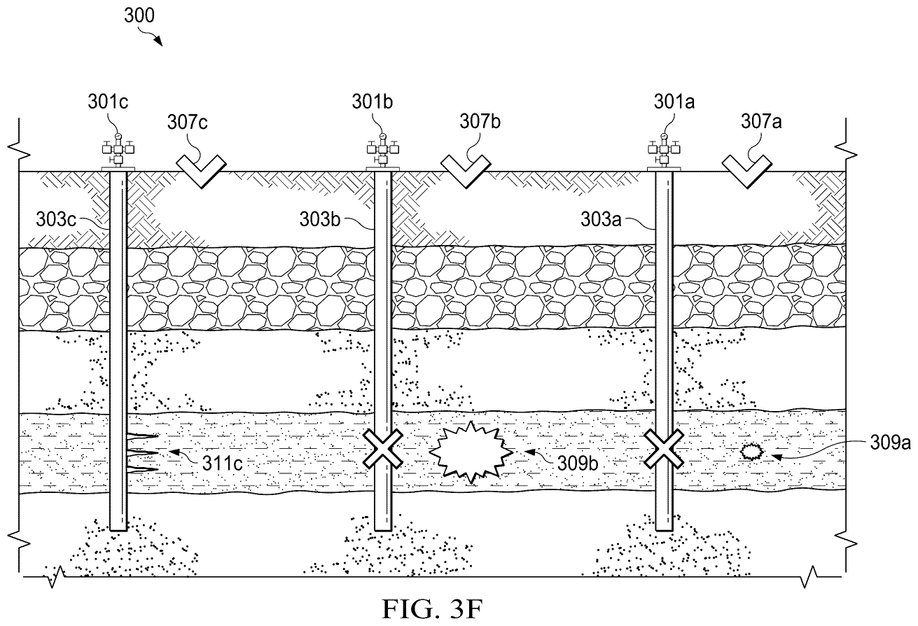

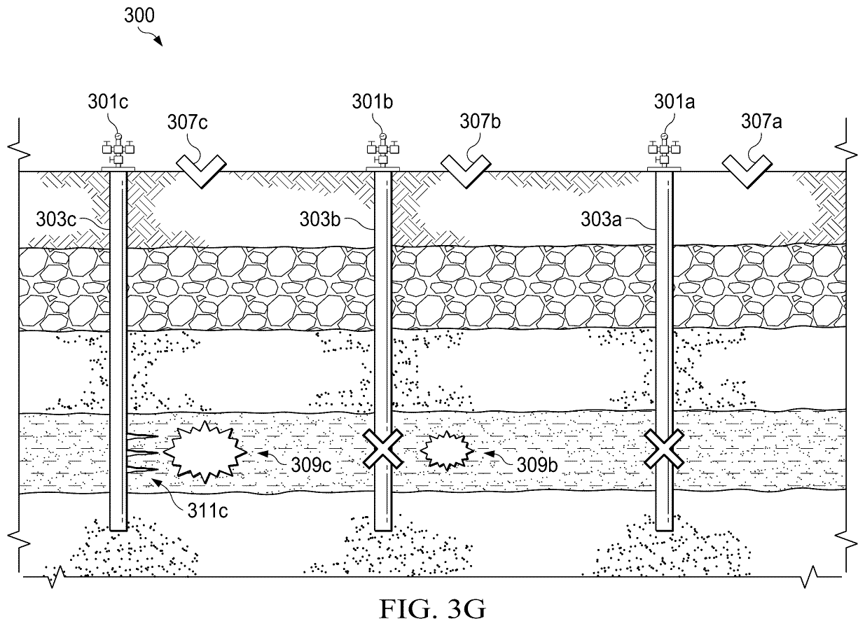

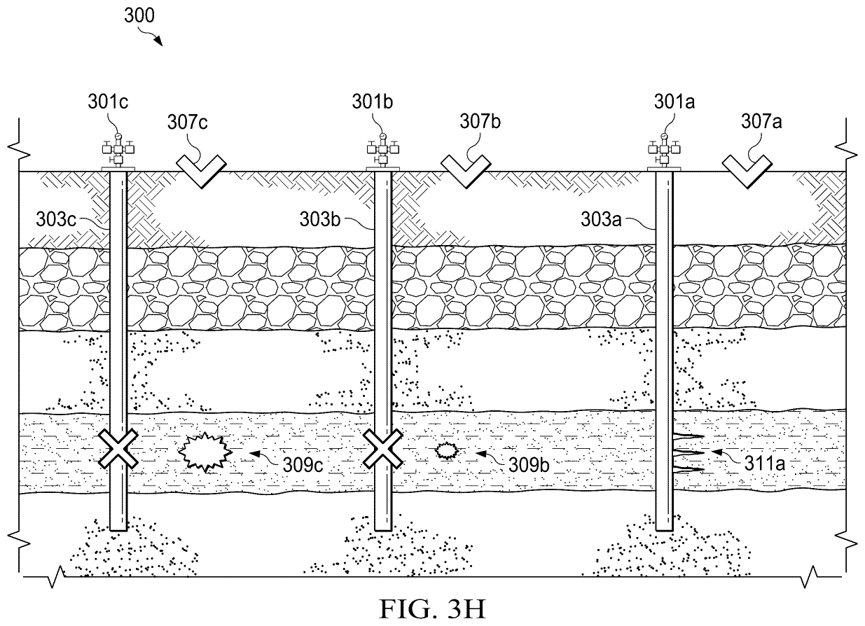

Although only three sleeves and three seismometers are shown, there may be many more covering the length of the well. Further, although a horizontal well is shown, the method can be implemented in vertical wells as shown in FIG. 3.

In more detail, in FIG. 3A we see well system 300 with wellhead 301a-c on top of each well 303a-b. Here, injection in well 303a, and well 303b-c closed or at least not in use. This continues until the pressure builds sufficiently that the stress overcomes the minimum principal stress, thus initiating a seismic event 309a which can be detected by sensitive equipment, here shown in FIG. 3B seismometer 307a. In FIG. 3C, well 303a is thus closed to allow the pressure around that well to dissipate, preventing seismicity from increasing, and instead, well 303b is opened for injection. Eventually, in FIG. 3D we see the pressure at well 303a subside. In FIG. 3E the pressure around well 303b exceeds minimum and another event 309b is detected, so the well 303b is closed in FIG. 3F and injection switched to 303c. In FIG. 3G an event 309c is detected at 303c, so in FIG. 3H well 303c is closed, and injection switched back to 303a.

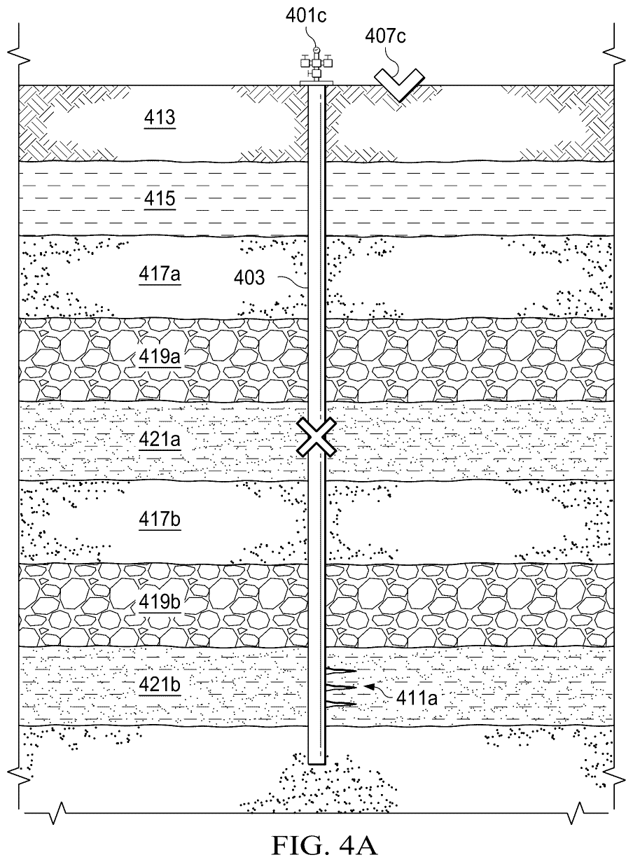

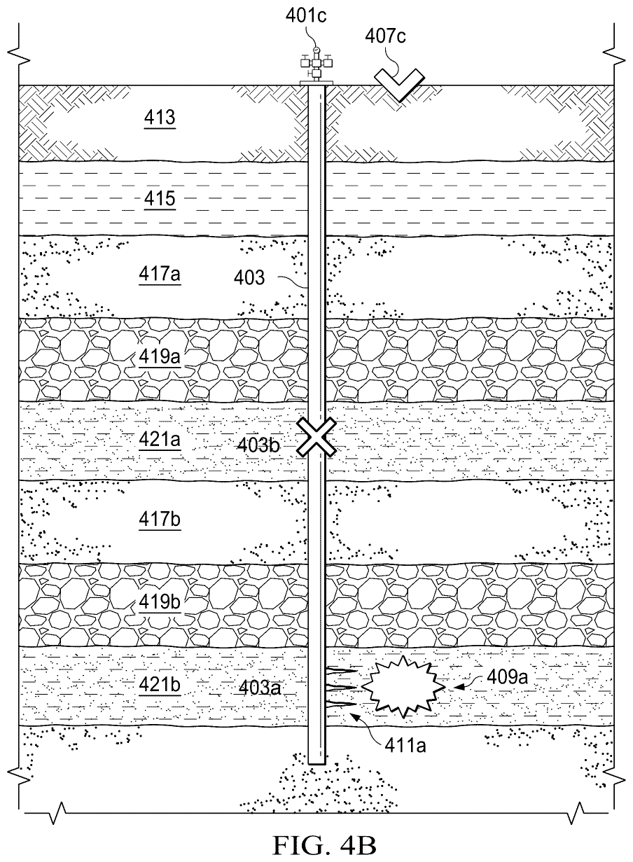

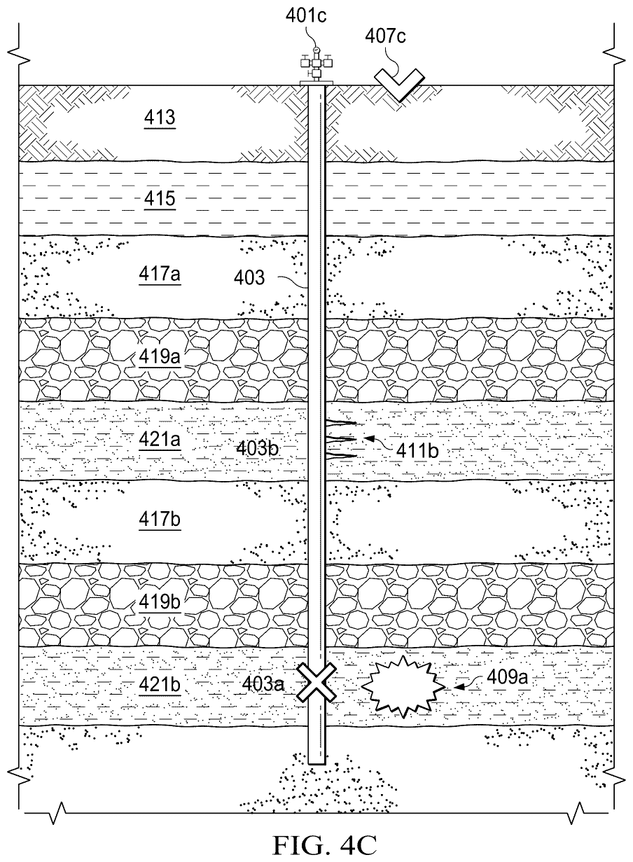

In FIG. 4 we see yet another variation where a vertical well is sufficiently deep to have well separated multiple porous zones suitable for disposal uses (only 2 shown). Here we see porous zones 421a-b each under a base layer 417a-b under rock layer 419 a-b. All of this is deeper than water layer 415 and soil layer 413 on top. In FIG. 4A we see injection 411a in well 403a, with well zone 403b closed, e.g., with packers, plugs, sliding sleeves and the like. This continues until the pressure builds sufficiently that the stress overcomes the minimum principal stress, thus initiating a seismic event 409a (FIG. 4B) which can be detected by sensitive equipment, e.g., seismometer 407c. In FIG. 4C, well 403a is thus closed to allow the pressure around that well to dissipate, preventing seismicity from increasing, and instead, well 403b is opened for injection (411b). This continues as needed, in the same manner shown in FIGS. 2 and 3. Of course, the second injection point need not be adjacent to the first injection point, as one could pick any distant injection point in the same or a different well.

As with horizontal wells, the selection of distant injection points is based on geology, well placement, regulations and where the seismic activity is detected. In FIG. 4 only one seismic detector is shown, and thus limited seismic information with depth is available, but with an array of seismic detectors, it may be possible to gain additional information, e.g., by triangulation.

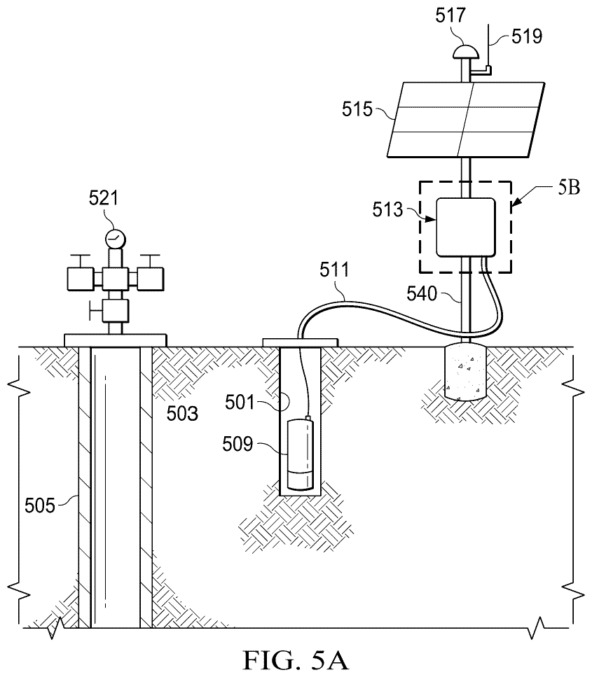

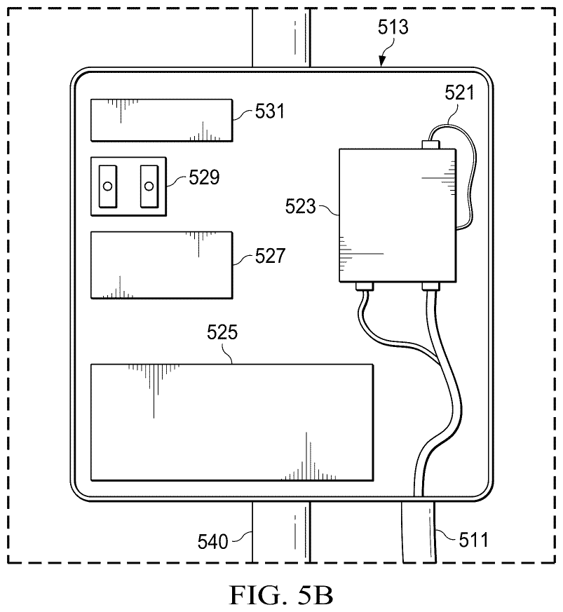

In FIG. 5 a posthole 501 is dug in the earth 503 directly adjacent well 505 in a reservoir. A seismometer 509 down the hole 501 is connected by cable 511 to communication system 513 and solar panel 515, GPS antenna 517 and cell antenna 519.

The communication system 513 wirelessly connects via 519 to a computerized piping control system 521, thereby controlling which valves are open and thereby controlling each injection point. This figure is simplified to only show a single vertical well, but a number of wells would be present.

In the expanded view of communication system 513 (in FIG. 5B), we see ethernet cable 521, a high speed connector, such as the Centaur 523 which can support many protocols like USB 3.0, 10G Ethernet, 25G Ethernet, 40G Ethernet, 100G Ethernet, SATA, eSATA, Micro-SATA, DVI, HDMI, and more. Also seen is battery 525, modem 527, circuit breakers 529 and solar power regulator 531. Cable bundle 511 includes wires for seismometer 509, solar panel 515, GPS antenna 517 and cell antenna 519. The system may be on a mounting pole 540, but this is optional, and it may be on a cement pad or other system. It may also be necessary to protect the setup from theft e.g., by enclosing it in a cage or housing.

The following references are incorporated by reference in their entirety for all purposes.
US20080151691 Method of monitoring microseismic events
US20180203143 Mapping fractures using micro-seismic events
US20230003119 Low frequency distributed acoustic sensing hydraulic fracture geometry
U.S. Pat. No. 8,902,710 Method for determining discrete fracture networks from passive seismic signals and its application to subsurface reservoir simulation
U.S. Pat. No. 9,347,313 Hydraulic fracture monitoring using active seismic sources with receivers in the treatment well
U.S. Pat. No. 9,506,339 Active seismic monitoring of fracturing operations and determining characteristics of a subterranean body using pressure data and seismic data
U.S. Pat. No. 9,513,402 Estimating fracture dimensions from microseismic data

1. A system for disposal of fluids in a reservoir, said system comprising:
a) a plurality of vertical or horizontal disposal wells in a reservoir, each disposal well cased and cemented;
b) each disposal well fitted with one or more controllable injection point(s) for directing fluid solely into a porous layer of said reservoir;
c) said porous layer under an impermeable layer and said impermeable layer under a soil layer;
d) a seismic detector on or in said soil layer over each said controllable injection point(s);
e) each said seismic detector operably connected to a computer system configured to detect a seismic event of a value greater than a predetermined threshold value and assign said seismic event to a particular controllable injection point.

2. The system of claim 1, said computer system operably connected to a piping control system configured to switch flow from a first controllable injection point to a second controllable injection point when said seismic event is detected at said first controllable injection point.

3. The system of claim 2, said computer system and piping control system configured to switch flow back to said first controllable injection point after said seismic event has dissipated.

4. The system of claim 1, wherein said first controllable injection point and said second controllable injection point are in one or more horizontal disposal well(s).

5. The system of claim 1, wherein said first controllable injection point and said second controllable injection point are in a horizontal disposal well and each controllable injection point is fitted with a multi-open-and-close hydraulic fracturing sleeve (MOC frac sleeve).

6. The system of claim 1, wherein said first controllable injection point and said second controllable injection point are in a horizontal disposal well and each controllable injection point is fitted with a MOC frac sleeve and wherein a seismic detector is positioned over each MOC frac sleeve.

7. The system of claim 2, wherein said first controllable injection point and said second controllable injection point are in a horizontal disposal well and each controllable injection point is fitted with a MOC frac sleeve and wherein a seismic detector is positioned over each MOC frac sleeve.

8. The system of claim 1, wherein said first controllable injection point and said second controllable injection point are in one or more vertical disposal well(s).

9. The system of claim 1, wherein said first controllable injection point and said second controllable injection point are independently in a horizontal disposal well or in a vertical disposal well or combinations thereof.

10. A fluid disposal method, said method comprising the following steps:
a) monitoring seismic activity in a reservoir throughout said method;
b) injecting a fluid to be disposed of into a first controllable injection point in a first disposal well in said reservoir;
c) continuing said injecting step until a seismic event of a predetermined value is detected;
d) closing said first injection point;
e) switching to injecting said fluid into a second controllable injection point at least 100 meters from said first injection point, said second controllable injection point in said first disposal well or in a second disposal well; and
f) wherein said method has less seismic risk than a disposal method performed without said seismic monitoring, closing and switching steps.

11. The method of claim 10, further comprising repeating steps c-e) with one or more additional controllable injection point(s) wherein any closed controllable injection point may be reopened for injection after said seismic event at said closed controllable injection point has dissipated.

12. The method of claim 10, wherein said first controllable injection point and said second controllable injection point are in one or more horizontal disposal well(s).

13. The method of claim 10, wherein said first controllable injection point and said second controllable injection point are in a horizontal disposal well and each controllable injection point is fitted with a multi-open-and-close hydraulic fracturing sleeve (MOC frac sleeve) and wherein a seismic detector is positioned over each MOC frac sleeve.

14. The method of claim 10, wherein said first controllable injection point and said second controllable injection point are in one or more vertical disposal well(s).

15. The method of claim 10, wherein said first controllable injection point and said second controllable injection point are independently in a horizontal disposal well or in a vertical disposal well or combinations thereof.

16. The method of claim 10, wherein any closed controllable injection point may be reopened for injection after said seismic event has dissipated.

17. The method of claim 10, wherein said method is repeated in one or more disposal wells until all of said fluid has been injected or until said reservoir is full.

18. The method of claim 10, wherein said method is repeated in a given disposal well until a maximum reservoir pressure is reached and then switching to injecting in a new disposal well.

19. The method of claim 10, wherein said monitoring is done with a seismic detector positioned over each controllable injection point.

20. A fluid disposal method, said method comprising the following steps in order:
a) monitoring seismic activity in a reservoir throughout said method;
b) injecting a fluid to be disposed of into a first controllable injection point in a first disposal well in said reservoir;
c) continuing said injecting step until a seismic event of a predetermined value is detected;
d) closing said first injection point and switching to injecting said fluid into a second controllable injection point at least 100 meters from said first injection point, said second controllable injection point in said first disposal well or in a second disposal well;
e) repeating steps c-d) with one or more additional controllable injection point(s);
f) wherein any closed controllable injection point may be reopened for injection after said seismic event at said closed controllable injection point has dissipated;
g) wherein said first controllable injection point and said second controllable injection point are in a horizontal disposal well and each controllable injection point is fitted with a multi-open-and-close hydraulic fracturing sleeve (MOC frac sleeve) and wherein a seismic detector is positioned over each MOC frac sleeve; and
h) wherein said method has less seismic risk than a disposal method performed without said seismic monitoring, closing and switching steps.
